(19) United States
(12) Patent Application Publication
(10) Pub. No.: US 2008/0212088 A1
(43) Pub. Date: Sep. 4, 2008

(54) Holographic Sensors and Their Uses

(76) Inventor: Christopher Creasey, Cambridge (GB)

Correspondence Address: SALIWANCHIK LLOYD & SALIWANCHIK;A PROFESSIONAL ASSOCIATION, PO BOX 142950, GAINESVILLE, FL, 32614-2950, US

(21) Appl. No.: 11/996,245

(22) PCT Filed: Jul. 18, 2006
(86) PCT No.: PCT/GB06/02668

§ 371 Date: May 20, 2008

(30) Foreign Application Priority Data
Jul. 18, 2005 (GB) 0514699.8

(51) Int. Cl. G01J 3/00

(52) U.S. Cl. 356/300

(57) ABSTRACT

A method of analysing a holographic sensor (1) comprising a hologram, wherein interaction of the holographic sensor with a stimulant causes a change in the wavelength of diffracted light from the hologram, comprises the steps of: a) viewing light diffracted by the hologram and specular reflections in an image plane of a lens; b) viewing light diffracted by the hologram and specular reflections in a focal plane of the lens or of a different lens; c) interacting the holographic sensor with a stimulant and determining the change in the wavelength of diffracted light; and d) using the information obtained to determine a property of the stimulant or of the sensor. A device suitable for use in such a method comprises a lens (3), means for detecting light in the image (4) and focal (5) planes of the lens, and image-processing software.

### FIELD OF THE INVENTION

This invention relates to a method for analysing a holographic sensor and to a device for use in such a method.

### BACKGROUND OF THE INVENTION

Holographic sensors are known, and are disclosed in, inter alia, WO95/26499 and WO99/63408. They comprise a holographic support medium which has, disposed throughout its volume, a hologram. Such holographic sensors are capable of detecting an analyte when the support medium interacts with the analyte, resulting in a variation of a physical property of the medium. This variation induces a change in an optical characteristic of the holographic element, such as its polarisability, reflectance, refractance or absorbance. The change in optical characteristics may be visible with a human eye or may be detected using a spectrometer if the position of the hologram is well controlled.

When using a spectrometer to make measurements on a hologram, the spectrometer must be aligned with the surface of the hologram. This can be difficult and time-consuming and, in practice, is usually carried out in a laboratory where the position of the hologram can be well controlled on an optical bench.

In many situations where a holographic sensor could be used, the hologram may be in a range of orientations and the hologram's position is not well controlled. There exists a need in the art for a method which would enable measurements of the optical properties of a holographic sensor to be made where the method is not dependent on the hologram having a predetermined fixed position.

### SUMMARY OF THE INVENTION

According to a first aspect of the present invention, in a method of analysing a holographic sensor comprising a hologram, wherein interaction of the holographic sensor with a stimulant causes a change in the wavelength of diffracted light from the hologram, the method comprises the steps of:
a) viewing light diffracted by the hologram and specular reflections in an image plane of a lens;
b) viewing light diffracted by the hologram and specular reflections in a focal plane of the lens or of a different lens;
c) interacting the holographic sensor with a stimulant and determining the change in the wavelength of diffracted light; and
d) using the information obtained to determine a property of the stimulant or of the sensor.

A second aspect of the present invention is a device suitable for use in the method of the invention, comprising a lens, means of detecting light in the image and focal planes, and image-processing software.

The method of the present invention allows the three-dimensional position of a hologram in a holographic sensor to be determined and hence the wavelength of diffracted light to be measured at a known diffraction angle. In practice, this means that the concentration or intensity of a stimulant to which the holographic sensor is sensitive can be determined quickly and easily in a wide variety of situations.

As the method itself can be used to determine the position of the hologram, it is not necessary to provide a sensor where the hologram is in a fixed predetermined position. This means that measurements can be conducted in situ; for example, where the sensor is part of a coating on a surface, measurements can be made using a device held close to the surface.

By viewing light diffracted by the hologram, the shape and/or any other distinguishing characteristics of the hologram can be identified. This is particularly valuable in a system where there is more than one type of sensor and the sensors have different sensitivities.

### BRIEF DESCRIPTION OF THE DRAWINGS

FIG. 1 is a schematic diagram of a device embodying the present invention;

FIG. 2 shows an image formed on the image plane sensor of the device in FIG. 1;

FIG. 3 shows images formed on the focal plane sensor of the device in FIG. 1;

FIG. 4 is a schematic diagram of another device embodying the present invention; and

FIG. 5 shows the images obtained at the image and focal planes, from the device in FIG. 4.

### DESCRIPTION OF THE INVENTION

In this specification, the term holographic sensor means a holographic element made up from a support medium with a hologram therein. The hologram can be dispersed in or on part of or throughout the bulk. The support medium interacts with a stimulant resulting in a variation of a physical property of the medium which induces a change in the optical characteristic of the hologram.

The hologram is a three-dimensional distribution (modulation) pattern which is a physical record of an original interference pattern and can be generated by the diffraction of light. Peaks of modulation are referred to as “fringes” and can be formed from silver grains. The hologram acts as a diffraction grating to filter light in accordance with the Bragg equation and variations in the physical properties of the support due to the interaction with a stimulant can alter the fringe separation, leading to a change in wavelength at a fixed angle of incidence or change in intensity at monochromic peak intensity. Hence, the extent of interaction between the support medium and the stimulant can be detected remotely, using non-ionising radiation and is measured by a shift in the wavelength of non-ionising radiation.

The stimulant can be an analyte such as a chemical, biochemical or biological species or a physical influence such as temperature, light, magnetism or pressure. The interaction can be a chemical reaction.

Known holographic sensors are used in the present invention which can be prepared according to known methods. Publications disclosing suitable holographic sensors and methods for their preparation include WO95/26499 and WO99/63408, the contents of which are incorporated by reference.

The magnitude of the change of the wavelength is related to the magnitude of physical change of the support medium, which is caused by and therefore related to the concentration or intensity of the stimulant.

However, in order to determine the change in peak wavelength resulting from interaction of the holographic element with the stimulant, it is necessary to determine the angle of incident light on the hologram which may change as a result of the interaction.

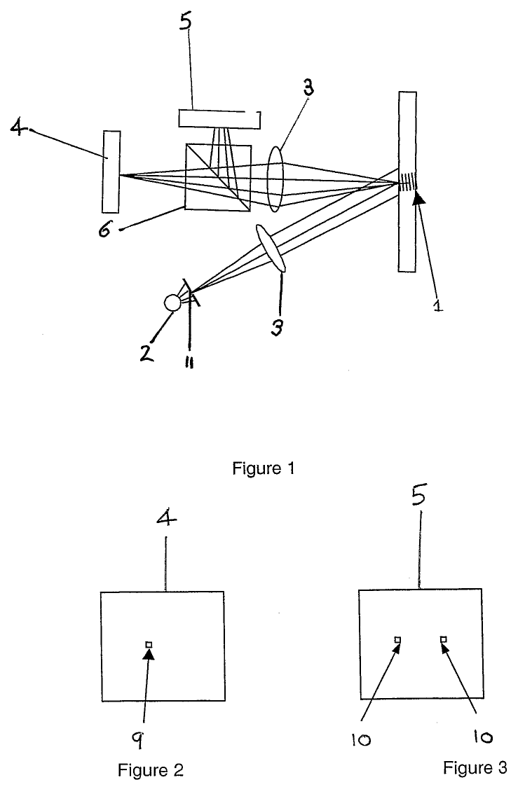

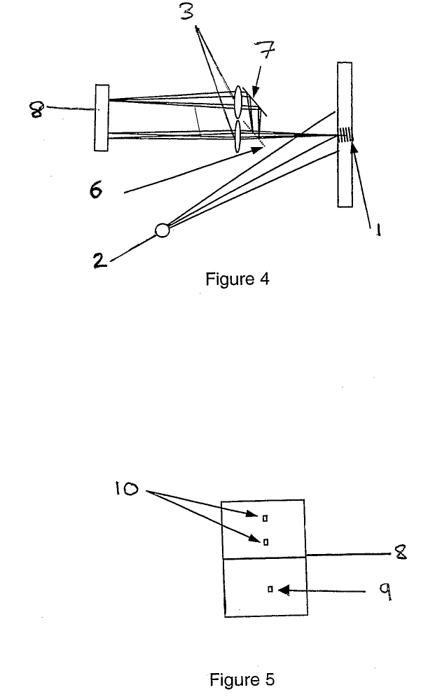

The invention will now be described by way of example only with reference to the accompanying drawings. In particular, FIGS. 1 and 4 illustrate how the method works.

The holographic sensor is illuminated with a light source 2 in order to view light diffracted and reflected by it. The light source may be included in the device or may be a separate source such as natural light. A pinhole 11 can be used with an extra lens 3 as in FIG. 1 to enhance the light from the light source. A lens 3 is used to view light diffracted by the hologram in an image plane on an image plane sensor 4, as shown in FIG. 2. The focusing of this image (which can be done manually by moving the instrument or automatically by moving the detector) is used to determine the three-dimensional position of the hologram relative to the instrument. This image can also be used to identify the hologram from its shape or other characteristics.

The light diffracted by the hologram is also viewed in a focal plane of a lens on a focal plane sensor 5 along with specular reflections from the surface of the sensor. The separation between the light from the hologram and, the specular reflections that can be seen in FIG. 3 indicates the angle of orientation of the hologram from the surface. Hence, a combination of the images from the image plane and focal plane can be used to determine the three-dimensional position and angular position of the hologram.

The optical configuration used to view light in the image and focal planes is flexible, as the method of the invention simply relies on obtaining information from the image and focal planes irrespective of the means used to do this.

FIG. 1 shows a beam splitter 6 which is used to direct light onto the focal plane and sensors in both the image plane 4 and focal plane 5. FIG. 4 shows a different embodiment, where two lenses are used but only one sensor. A beam splitter 6 is used in combination with a mirror 7 to direct light through the different lenses 3 onto a detector 8 which is used to view light in the image and focal planes. FIG. 5 shows the diffracted light from the hologram viewed in the image plane 9 and the light from hologram and specular reflections viewed in the focal plane 10.

Image-processing software is generally used to analyse the light on the image plane and focal planes. Such software is readily available and/or can be modified for use in the invention by one of ordinary skill in the art.

Once the position of the hologram is known, the light viewed in the focal plane can be used to determine the RGB colour coordinates of the diffracted beam and hence the wavelength of the light from the hologram.

Various steps are preferably included in the method to optimise the light signal viewed. For example, the device used in the method is preferably aligned with the sensor. Once the position of the sensor has been determined, the software in the device can indicate if any movement of the device is needed to provide optimal results.

Further, in addition to the light diffracted by the hologram, there will also be a background level of scattered light, for example the diffuse reflections from the holographic sensor. Preferably, the method involves viewing and measuring the background scattered light and compensating for it to give a more accurate measurement of the diffracted light in the hologram. This can be achieved using image-processing software.

The source of light can also be optimised in terms of intensity or wavelength to provide optimum images. This involves providing an adjustable light source and adjusting the intensity or wavelength of the light to achieve the optimum results.

In any system where holographic sensors are used, it may be desirable to detect more than one stimulant. Different holographic sensors can be provided within one article which are sensitive to different stimulants. In this situation, it is highly desirable to differentiate light from the different sensors to determine which holographic sensor is being analysed.

The present invention provides a means of doing this, as the light diffracted from the hologram in an image plane can be used to identify the hologram. Once the initial position of the hologram has been determined, the method of the invention allows for the detection of a stimulant to which the holographic sensor is sensitive.

The method additionally comprises the steps of interacting the holographic sensor with a stimulant and determining the change in the wavelength of diffracted light. As discussed above, the change in wavelength can be used to determine the concentration or intensity of the stimulant.

In one embodiment of the invention, the medium comprises a first polymer interpenetrated by a second, different polymer, and wherein the hologram is recorded in the first polymer and said variation arises as a result of interaction between the second polymer and an analyte. The first polymer can be gelatin. The first polymer may also be is sensitive to a second analyte.

The hologram can be viewable under various conditions. For example, the hologram may only be visible under magnification or may be viewable under white light, UV light or infra-red radiation and/or under specific temperature, magnetism or pressure conditions. The holographic image is typically an object or a 2- or 3-dimensional effect. The holographic sensor may comprises means for producing an interference effect when illuminated with laser light, such as a depolarising layer.

More than one hologram may be supported on, or in, a holographic element in the support medium. The holographic element may be dimensioned and arranged so as to sense two independent events and to effect, simultaneously or otherwise, radiation in two different ways. Holographic elements may be provided in the form of an array.

The present invention also relates to a device for use in the method comprising a lens, means of detecting the light in the image and focal planes and image processing software. Preferably a sensor is used to view light in the image plane and focal plane. The device may be incorporated into a camera, mobile phone or any type of reader. The device may have wired or wireless connectivity functionality such as RS232, USB, Wi-Fi or Bluetooth.

The holographic sensor that is analysed in the method of the invention may be part of an article or part of a transferable holographic film which is, for example, provided on a hot stamping tape. The article may be a transaction card, banknote, passport, identification card, smart card, driving licence, share certificate, bond, cheque, cheque card, tax banderole, gift voucher, postage stamp, rail or air ticket, telephone card, lottery card, event ticket, credit or debit card, business card, or an item used in consumer, brand and product protection for the purpose of distinguishing genuine products from counterfeit products and identifying stolen products.

The article may be used to provide product and pack information for intelligent packaging applications. “Intelligent packaging” refers to a system that comprises part of, or an attachment to, a container, wrapper or enclosure, to monitor, indicate or test product information or quality or environmental conditions that will affect product quality, shelf life or safety and typical applications, such as indicators showing time-temperature, freshness, moisture, alcohol, gas, physical damage and the like.

Alternatively, the article may be a decorative element or application such as any industrial or handicraft item including but not limited to items of jewelry, items of clothing (including footwear), fabric, furniture, toys, gifts, household items (including crockery and glassware), architecture (including glass, tile, paint, metals, bricks, ceramics, wood, plastics and other internal and external installations), art (including pictures, sculpture, pottery and light installations), stationery (including greetings cards, letterheads and promotional material) and sporting goods.

The article may be a diagnostic device such as a test strip, chip, cartridge, swab, tube, pipette or any form of liquid sampling or testing device, and products or processes relating to human or veterinary prognostics, theranostics, diagnostics or medicines. The article may be used in a contact lens, sub-conjunctival implant, sub-dermal implant, test strip, chip, cartridge, swab, tube, breathalyser, catheter, any form or blood, urine or body fluid sampling or analysis device. The article may also be used in a product or process relating to petrochemical and chemical analysis and testing, for example in a testing device such as a test strip, chip, cartridge, swab, tube, pipette or any form of liquid sampling or analysis device.

1. A method of analyzing a holographic sensor comprising a hologram wherein interaction of the holographic sensor with a stimulant causes a change in the wavelength of diffracted light from the hologram, the method comprising the steps of:
a) viewing light diffracted by the hologram and specular reflections in an image plane of a lens,
b) viewing light diffracted by the hologram and specular reflections in a focal plane of the lens or of a different lens;
c) interacting the holographic sensor with a stimulant and determining the change in the wavelength of diffracted light; and
d) using the information obtained in steps a) and b) to determine a property of the sensor or using the information obtained in steps a), b) and c) to determine a property of the stimulant.

2. The method according to claim 1, wherein step (d) comprises identifying the hologram.

3. The method according to claim 1, wherein step (d) comprises determining the concentration, intensity or identity of the stimulant.

4. The method according to claim 1, including the step of providing an adjustable light source and adjusting the intensity or wavelength of the light.

5. The method according to claim 1, additionally comprising the steps of viewing, measuring and compensating for background scattered light.

6. The method according to claim 1, wherein the hologram is a volume hologram.

7. The method according to claim 1, wherein the holographic sensor comprises a medium and, disposed therein, a hologram, wherein an optical characteristic of the hologram changes as a result of a variation of a physical property of the medium, wherein the medium comprises a first polymer interpenetrated by a second, different polymer, and wherein the hologram is recorded in the first polymer and said variation arises as a result of interaction between the second polymer and the stimulant which is an analyte.

8. The method according to claim 7, wherein the first polymer is gelatin and/or the fringes of the hologram are formed by silver grains.

9. The method according to claim 7, wherein the interaction is a chemical reaction.

10. The method according to claim 7, wherein the first polymer is sensitive to a second analyte.

11. The method according to claim 1, wherein the hologram is generated by the diffraction of light.

12. The method according to claim 1, wherein the hologram is only visible under magnification.

13. The method according to claim 1, wherein a holographic image is of an object or is a 2- or 3-dimensional effect.

14. The method according to claim 1, wherein the holographic sensor comprises means for producing an interference effect when illuminated with laser light.

15. The method according to claim 14, wherein the means comprises a depolarizing layer.

16. The method according to claim 11, wherein the hologram is viewable under white light, UV light or infra-red radiation.

17. The method according to claim 1, wherein the hologram is viewable under specific temperature, magnetism or pressure conditions.

18. The method according to claim 1, wherein the holographic sensor is part of an article.

19. The method according to claim 18, wherein the article is a transaction card, banknote, passport, identification card, smart card, driving license, share certificate, bond cheque, cheque card, tax banderole, gift voucher, postage stamp, tail or air ticket, telephone card, lottery card, event ticket, credit or debit card, business card, or an item used in consumer, brand or product protection for the purpose of distinguishing genuine products from counterfeit products or identifying stolen products.

20. The method according to claim 18, wherein the article is an item of intelligent packaging as defined herein.

21. The method according to claim 18, wherein the article is an industrial or handicraft item comprising a decorative element, selected from items of jewelry, items of clothing, fabric, furniture, toys, gifts, household items, architecture, art, stationery and sporting goods.

22. The method according to claim 18, wherein the article is a product or device for use in agricultural studies, environmental studies, human or veterinary prognostics, theranostics, diagnostics, therapy or chemical analysis.

23. The method according to claim 22, wherein the article is a test strip, chip, cartridge, swab, tube, pipette, contact lens, sub-conjunictival implant, sub-dermal implant, breathalyzer, catheter or a fluid sampling or analysis device.

24. The method according to claim 1, wherein the holographic sensor is a part of a transferable holographic film.

25. The method according to claim 24, wherein the film is present on a hot stamping tape.

26. The method according to claim 24, comprising the step of enhancing the security of an article by transferring onto the article the sensor from the film.

27. A device comprising a lens, means for detecting light in the image and focal planes, and image-processing software.

28. The device according to claim 27, wherein the device is a part of a camera, mobile phone, or reader.

29. The device according to claim 27, that has wired or wireless connectivity functionality such as RS232, USB, Wi-Fi or Bluetooth.
